(19) United States
(12) Patent Application Publication
(10) Pub. No.: US 2022/0164761 A1
(43) Pub. Date: May 26, 2022

(54) DISTRIBUTION BASE MOBILITY SYSTEM, DISTRIBUTION MANAGING DEVICE, AND DISTRIBUTION MANAGEMENT METHOD

(71) Applicant: TOYOTA JIDOSHA KABUSHIKI KAISHA, Aichi-ken (JP)

(72) Inventors: Tetsuya KANATA, Toyota-shi (JP); Masao TAJIMA, Toyota-shi (JP); Takashi HAYASHI, Toyota-shi (JP); Nobuyuki TOMATSU, Nagoya-shi (JP); Hideki FUKUDOME, Nisshin-shi (JP); Takashi HAYASHI, Nagoya-shi (JP); Yoshiumi KAWAMURA, Nisshin-shi (JP); Kosuke AKATSUKA, Mishima-shi (JP); Manabu YAMAMOTO, Toyota-shi (JP); Kosuke SAKAKIBARA, Toyota-shi (JP)

(21) Appl. No.: 17/506,674

(22) Filed: Oct. 21, 2021

(30) Foreign Application Priority Data
Nov. 25, 2020 (JP) 2020-195415

(51) Int. Cl. G06Q 10/08; G01C 21/34

(52) U.S. Cl. CPC G06Q 10/083; G08G 1/123; G01C 21/3438

(57) ABSTRACT

A distribution base mobility system that acquires position information of a distribution base vehicle, position information for a location where the distribution base vehicle is able to park to exchange distribution items between the distribution base vehicle and the moving bodies, and information relating to a distribution request from a user, creates a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and notifies the distribution base vehicle of the created transit plan, and notify the moving bodies of position information of the distribution base vehicle based on the acquired information.

### CROSS-REFERENCE TO RELATED APPLICATION

This application is based on and claims priority under 35 USC 119 from Japanese Patent Application No. 2020-195415 filed on Nov. 25, 2020, the disclosure of which is incorporated by reference herein.

### BACKGROUND

### Technical Field

The present disclosure relates to a distribution base mobility system, a distribution managing device, and a distribution management method.

### Related Art

Various systems relating to the package distribution are known (see for example Japanese Patent Application Laid-Open (JP-A) Nos. 2019-133373, 2019-139264, and 2012-121700). For example, JP-A No. 2019-133373 discloses a collection and delivery system including a server device and plural self-driven moving bodies for collecting and delivering packages. In this system, the server device includes an information gathering section that gathers information relating to the self-driven moving bodies, and a command section that generates operation commands for the self-driven moving bodies. In cases in which a predetermined condition relating to transportation cost is satisfied, the command section issues a package loading operation command to one self-driven moving body out of a group of plural self-driven moving bodies present within a predetermined range of a predetermined point. Such a collection and delivery system enables transportation costs to be reduced.

The technology described above is not concerned with reducing overall loss when the plural self-driven moving bodies return to a distribution base in order to pick up distribution items.

### SUMMARY

An aspect of the disclosure is a distribution base mobility system that includes: a distribution base vehicle that is mobile and configures a distribution base for exchanging distribution items with a plurality of moving bodies that distribute distribution items in respective designated areas; and a processor that is configured to: acquire position information of the distribution base vehicle, position information for a location where the distribution base vehicle is able to park to exchange distribution items between the distribution base vehicle and the moving bodies, and information relating to a distribution request from a user; create a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and notify the distribution base vehicle of the created transit plan, and notify the moving bodies of position information of the distribution base vehicle based on the acquired information.

### BRIEF DESCRIPTION OF DRAWINGS

FIG. 1 is a diagram illustrating an example of a schematic configuration of a distribution base mobility system according to an exemplary embodiment;

FIG. 2A is a block diagram illustrating part of a hardware configuration of a distribution vehicle;

FIG. 2B is a block diagram illustrating part of a hardware configuration of a distribution base vehicle;

FIG. 3 is a block diagram illustrating an example of a hardware configuration of a distribution management device;

FIG. 4 is a block diagram illustrating an example of a functional configuration of a distribution management device; and

FIG. 5 is a flowchart illustrating an example of a flow of processing executed by a distribution management device.

### DETAILED DESCRIPTION

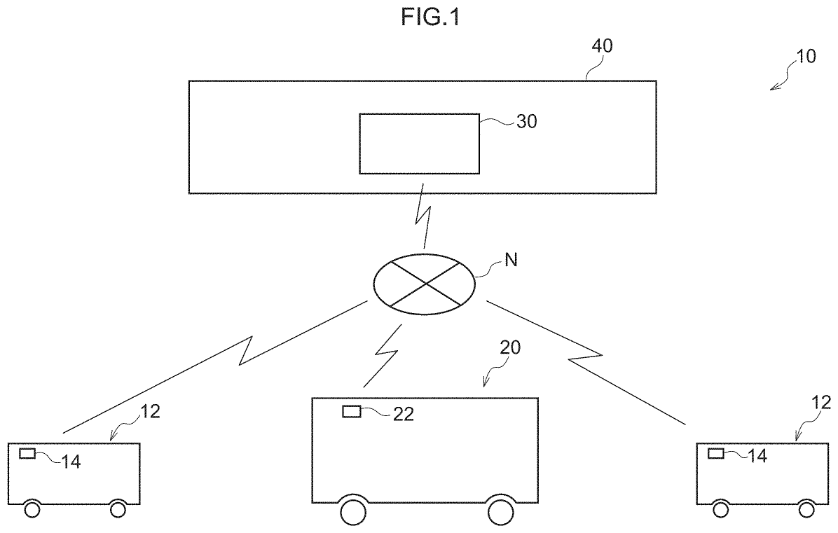

Explanation follows regarding a distribution base mobility system of the present disclosure, with reference to FIG. 1 to FIG. 5.

### Schematic Configuration of Distribution Base Mobility System 10

FIG. 1 illustrates an example of a schematic configuration of a distribution base mobility system 10 according to an exemplary embodiment. As illustrated in FIG. 1, the distribution base mobility system 10 includes a distribution base vehicle 20 and a distribution management device 30. The distribution management device 30 is provided at a logistics center 40. Packages for distribution (distribution items) are accumulated at the logistics center 40.

The distribution base vehicle 20 is a large mobile vehicle that is capable of being loaded with distribution items and that configures a distribution base for exchanging distribution items with distribution vehicles 12, serving as plural moving bodies that distribute distribution items in respective designated areas. Distribution items for delivery within a predetermined district are loaded onto the distribution base vehicle 20 at the logistics center 40. The distribution base vehicle 20 is loaded with plural trolleys, each of which is capable of carrying plural distribution items, that can be taken on and off the distribution base vehicle 20. Each of the plural distribution vehicles 12 travels around delivering distribution items to distribution destinations within its designated area. Once all of the distribution items loaded in a distribution vehicle 12 have been delivered, the distribution vehicle 12 moves to an exchange location for distribution item exchange with the distribution base vehicle 20 in order to pick up more distribution items.

As an example, the distribution vehicles 12 and the distribution base vehicle 20 are respectively configured by autonomously driven electric vehicles that are capable of self-driven on-road travel, and each includes control functionality for implementing self-driven travel in response to notifications from the distribution management device 30. Note that the distribution vehicles 12 and the distribution base vehicle 20 may travel either with or without occupants. Alternatively, the distribution vehicles 12 and the distribution base vehicle 20 may be configured by vehicles in which an occupant either drives the vehicle or supplements driving according to the situation. An onboard unit 14 is installed in each of the distribution vehicles 12. An onboard unit 22 is installed in the distribution base vehicle 20.

The respective onboard units 14 of the plural distribution vehicles 12, the onboard unit 22 of the distribution base vehicle 20, and the distribution management device 30 are connected to each other over a network N. Note that although FIG. 1 illustrates an example in which two onboard units 14 and a single onboard unit 22 are connected to a single distribution management device 30, the number of connected onboard units 14 and onboard units 22 is not limited thereto.

### Configuration of Distribution Vehicles 12 and Distribution Base Vehicle 20

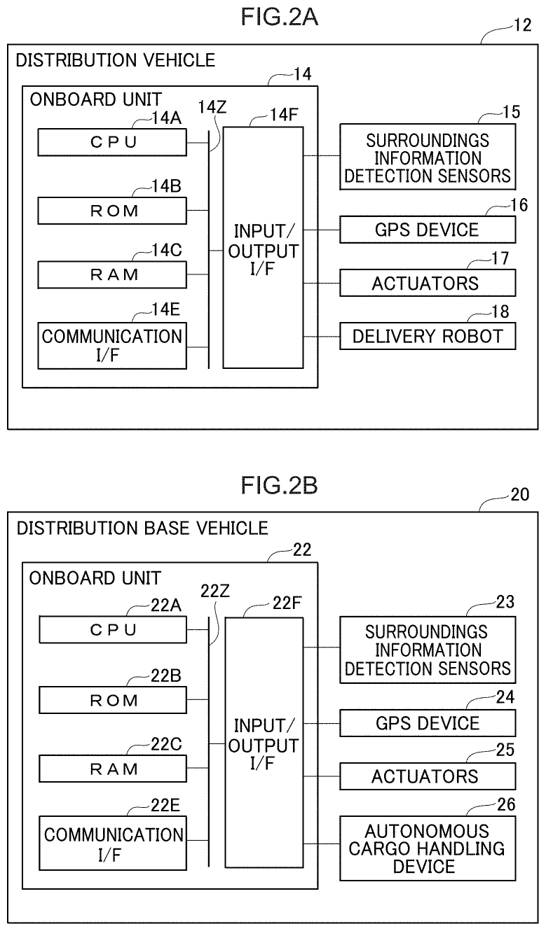

FIG. 2A is a block diagram illustrating part of a hardware configuration of a distribution vehicle 12. As illustrated in FIG. 2A, the distribution vehicle 12 includes the onboard unit 14, surroundings information detection sensors 15, a global positioning system (GPS) device 16, actuators 17, and a delivery robot 18. FIG. 2B is a block diagram illustrating part of a hardware configuration of the distribution base vehicle 20. As illustrated in FIG. 2B, the distribution base vehicle 20 includes the onboard unit 22, surroundings information detection sensors 23, a GPS device 24, actuators 25, and an autonomous cargo handling device 26.

The surroundings information detection sensors 15, 23 illustrated in FIG. 2A and FIG. 2B each include sensors for detecting surroundings information of the corresponding vehicle (i.e. the distribution vehicle 12 in FIG. 2A, and the distribution base vehicle 20 in FIG. 2B) for use in self-driven travel by the corresponding vehicle. The GPS devices 16, 24 acquire a current position of the corresponding vehicle. The actuators 17, 25 perform acceleration, deceleration, and steering of the corresponding vehicle. As an example, when the distribution vehicle 12 arrives in the vicinity of a distribution destination, the delivery robot 18 illustrated in FIG. 2A activates so as extract the corresponding distribution item from the distribution vehicle 12 and deliver the distribution item to the distribution destination. As an example, when the distribution base vehicle 20 arrives at a site for unloading distribution items, the autonomous cargo handling device 26 illustrated in FIG. 2B executes autonomous cargo handling tasks.

The onboard unit 14 illustrated in FIG. 2A includes a central processing unit (CPU; hardware processor) 14A, read only memory (ROM) 14B serving as an example of memory, random access memory (RAM) 14C, a communication interface (I/F) 14E, and an input/output I/F 14F. The CPU 14A, the ROM 14B, the RAM 14C, the communication I/F 14E, and the input/output I/F 14F are connected so as to be capable of communicating with each other through a bus 14Z.

Similarly, the onboard unit 22 illustrated in FIG. 2B includes a CPU 22A, ROM 22B, RAM 22C, a communication I/F 22E, and an input/output I/F 22F. The CPU 22A, the ROM 22B, the RAM 22C, the communication I/F 22E, and the input/output I/F 22F are connected so as to be capable of communicating with each other through a bus 22Z.

The CPUs 14A, 22A illustrated in FIG. 2A and FIG. 2B are each configured by a central processing unit that executes various programs and controls various sections. Namely, the CPU 14A reads and loads a program from the ROM 14B, and executes the program using the RAM 14C as a workspace. The CPU 22A reads a program from the ROM 22B, and executes the program using the RAM 22C as a workspace.

The ROMs 14B, 22B each hold various programs including an autonomous driving program, and various data. Note that in the present exemplary embodiment, as an example, the ROM 14B of the distribution vehicle 12 holds a program for causing the distribution vehicle 12 to move to exchange locations to exchange distribution items between the distribution vehicle 12 and the distribution base vehicle 20 in cases in which the distribution vehicle 12 needs to pick up distribution items, based on position information of the distribution base vehicle 20. The RAMs 14C, 22C each act as a workspace to temporarily store programs or data. The communication I/Fs 14E, 22E are each configured by a wireless communication module for communicating with the distribution management device 30 (see FIG. 1) and so on. The wireless communication modules employ a communication protocol such as 5G, LTE, or Wi-Fi (registered trademark). The communication I/Fs 14E, 22E are connected to the network N (see FIG. 1).

The input/output I/Fs 14F, 22F are each configured by an interface for communicating with the respective devices installed in the corresponding vehicle (i.e. the distribution vehicle 12 in FIG. 2A, and the distribution base vehicle 20 in FIG. 2B). As an example, the surroundings information detection sensor 15, the GPS device 16, the actuator 17, and the delivery robot 18 are each connected to the onboard unit 14 illustrated in FIG. 2A through the input/output I/F 14F. As an example, the surroundings information detection sensor 23, the GPS device 24, the actuator 25, and the autonomous cargo handling device 26 are each connected to the onboard unit 22 illustrated in FIG. 2B through the input/output I/F 22F.

The onboard units 14, 22 provide position information acquired by the GPS devices 16, 24 of the corresponding vehicle and information relating to a loading state of the corresponding vehicle to the distribution management device 30 (see FIG. 1). This information relating to the loading state of the corresponding vehicle includes a number of distribution items loaded. Note that this information relating to the loading state of the corresponding vehicle is automatically updated as required by input of the loading state as detected by a sensor or the like. The onboard units 14, 22 also receive notification information from the distribution management device 30.

### Configuration of Distribution Management Device 30

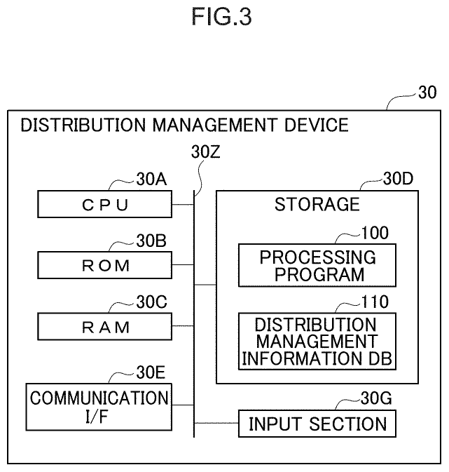

FIG. 3 is a block diagram illustrating an example of a hardware configuration of the distribution management device 30. As illustrated in FIG. 3, the distribution management device 30 includes a CPU 30A, ROM 30B, RAM 30C, storage 30D, a communication IN 30E, and an input section 30G. The CPU 30A, the ROM 30B, the RAM 30C, the storage 30D, the communication I/F 30E, and the input section 30G are connected so as to be capable of communicating with each other through a bus 30Z.

The CPU 30A may be configured by similar hardware to the CPUs 14A, 22A described previously, and the ROM 30B may be configured by similar hardware to the ROMs 14B, 22B described previously. The RAM 30C may be configured by similar hardware to the RAMs 14C, 22C described previously, and the communication I/F 30E may be configured by similar hardware to the communication I/Fs 14E, 22E described previously. The input section 30G is a unit that allows an input operation to be performed.

The storage 30D is configured by a hard disk drive (HDD) or a solid state drive (SSD), and stores various programs and various data. A program stored in the storage 30D is read by the CPU 30A, and the CPU 30A executes this program using the RAM 30C as a workspace. As an example, a processing program 100 and a distribution management information database (DB) 110 are stored in the storage 30D of the present exemplary embodiment.

The processing program 100 is a program executed in order to cause the distribution base mobility system to function. The distribution management information DB 110 is a database used to compile distribution management information including a transit plan of the distribution base vehicle 20 (described in detail later) and a distribution plan for each of the distribution vehicles 12 (described in detail later).

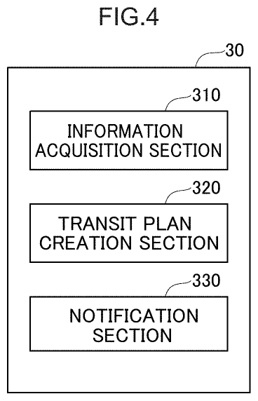

Next, explanation follows regarding functional configuration implemented by the distribution management device 30. FIG. 4 is a block diagram illustrating an example of the functional configuration of the distribution management device 30.

As illustrated in FIG. 4, the functional configuration of the distribution management device 30 includes an information acquisition section 310, a transit plan creation section 320, and a notification section 330. The respective functional configuration is implemented by the CPU 30A reading, loading, and executing the processing program 100 stored in the storage 30D.

The information acquisition section 310 acquires position information of the distribution base vehicle 20, position information for a location where the distribution base vehicle 20 is able to park to exchange distribution items between the distribution base vehicle 20 and the distribution vehicles 12, and information relating to distribution requests from users. The information acquisition section 310 also acquires information relating to factors that might affect a transit time of at least one out of the distribution base vehicle 20 or the distribution vehicles 12.

Note that this position information for the location where the distribution base vehicle 20 is able to park to exchange distribution items between the distribution base vehicle 20 and the distribution vehicles 12 may for example be acquired from an external server over the network N. The information relating to distribution requests from users includes information such as the number and size of distribution items, a distribution destination address (position information), whether or not a delivery time window has been specified, and the delivery time window if specified, for each distribution destination. This information may for example be input via the input section 30G of the distribution management device 30, or may be input via a separate terminal. The information relating to factors that might affect a transit time of at least one out of the distribution base vehicle 20 or the distribution vehicles 12 includes local traffic information (including predicted congestion information), meteorological information (including weather forecasts), and so on. This information can be acquired from various servers over the network N.

The transit plan creation section 320 creates a transit plan based on the information acquired by the information acquisition section 310. The transit plan includes a transit destination and transit timings of the distribution base vehicle 20 set so as to reduce overall loss when the plural distribution vehicles 12 move to an exchange location for distribution item exchange with the distribution base vehicle 20 in order to pick up distribution items. In the present exemplary embodiment, the transit plan creation section 320 creates the transit plan based on the information acquired by the information acquisition section 310 such that the number of the distribution items in a state carried by the distribution base vehicle 20 becomes zero in the shortest time. More specifically, the transit plan creation section 320 creates a transit plan giving the shortest possible transit time for distribution items, and furthermore, creates the transit plan such that this transit time approaches zero.

The notification section 330 notifies the distribution base vehicle 20 of the transit plan created by the transit plan creation section 320, and notifies the distribution vehicles 12 of the position information of the distribution base vehicle 20 based on the information acquired by the information acquisition section 310.

### Flow of Processing by Distribution Management Device 30

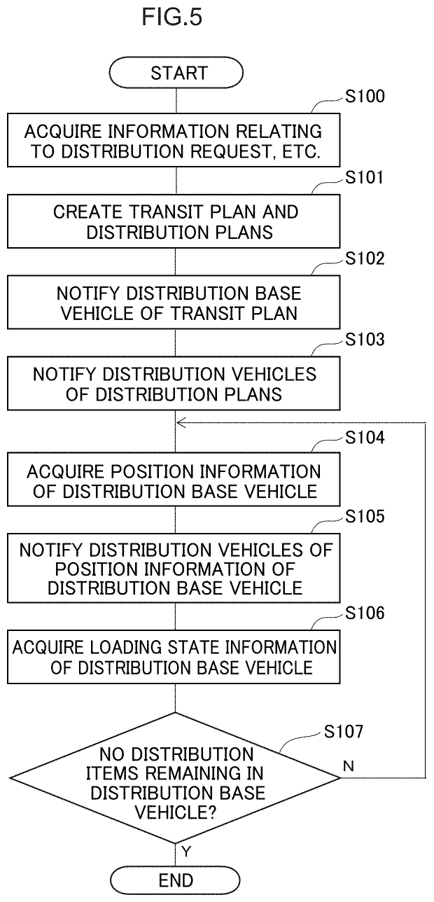

Next, explanation follows regarding a flow of processing executed by the distribution management device 30 as operation of the present exemplary embodiment, with reference to the flowchart in FIG. 5. As an example, at a stage at which the distribution base vehicle 20 has picked up distribution items destined for its allocated district at the logistics center 40 illustrated in FIG. 1, in cases in which a predetermined operation is performed via the input section 30G of the distribution management device 30 illustrated in FIG. 3 (or via a portable terminal), the CPU 30A reads the processing program 100 from the storage 30D and expands this program in the RAM 30C for execution in order to perform the processing illustrated in FIG. 5.

First, the CPU 30A acquires information relating to distribution requests from users, information relating to factors that might affect the transit time of at least one out of the distribution base vehicle 20 or the distribution vehicles 12, and position information for a location where the distribution base vehicle 20 is able to park to exchange distribution items between the distribution base vehicle 20 and the distribution vehicles 12 (step S100).

Next, the CPU 30A creates a transit plan for the distribution base vehicle 20 and respective distribution plans for the plural distribution vehicles 12 based on the information acquired at step S100 (step S101).

To explain the creation of the transit plan in more detail, the CPU 30A creates the transit plan including a transit destination and transit timings (transit times) of the distribution base vehicle 20 so as to reduce overall loss when the plural distribution vehicles 12 move to an exchange location for distribution item exchange with the distribution base vehicle 20 in order to pick up distribution items. As an example, in the present exemplary embodiment, the CPU 30A creates the transit plan such that the number of distribution items in a state carried by the distribution base vehicle 20 becomes zero.

To explain the creation of the distribution plans in more detail, the CPU 30A creates each of the distribution plans based on the total number of distribution items scheduled to be loaded onto the corresponding distribution vehicle 12, the number and size of the distribution items to be distributed to each of the distribution destinations, the distribution destination addresses (position information), a standard distribution route of the corresponding distribution vehicle 12, and the delivery time windows if specified. At least the distribution items to be distributed by the distribution vehicle 12 and scheduled arrival times at each distribution destination are stipulated by the distribution plan. As an example, the distribution route is also included in each of the distribution plans in the present exemplary embodiment.

Next, the CPU 30A notifies the distribution base vehicle 20 of the transit plan created at step S101 (step S102). In the present exemplary embodiment, as an example, in addition to the transit plan, the CPU 30A also transmits commands to the distribution base vehicle 20 to cause the distribution base vehicle 20 to move under autonomous driving according to the transit plan.

Next, the CPU 30A notifies the respective distribution vehicles 12 of the distribution plans created at step S101 (step S103). In the present exemplary embodiment, as an example, in addition to the distribution plans, the CPU 30A also transmits commands to the respective distribution vehicles 12 to cause the distribution vehicles 12 to move under autonomous driving according to the distribution plan.

Next, the CPU 30A acquires position information of the distribution base vehicle 20 (step S104). The CPU 30A then notifies the distribution vehicles 12 of this position information of the distribution base vehicle 20 (step S105). This notification enables each of the distribution vehicles 12 to move to an exchange location for distribution item exchange with the distribution base vehicle 20 in cases in which the distribution vehicle 12 needs to pick up distribution items.

Next, the CPU 30A acquires information relating to the loading state of the distribution base vehicle 20 (step S106). The CPU 30A then determines whether or not there are no distribution items remaining in the distribution base vehicle 20 (in other words, determines whether or not the number of distribution items being carried on the distribution base vehicle 20 is zero) (step S107). In cases in which distribution items remain in the distribution base vehicle 20 (step S107: N), the CPU 30A returns to the processing of step S104. However, in cases in which no distribution items remain in the distribution base vehicle 20 (step S107: Y), the CPU 30A ends the processing based on the processing program 100.

By executing the above processing, the distribution base vehicle 20 moves according to the transit plan, and the distribution vehicles 12 that need to pick up distribution items move to an exchange location for distribution item exchange with the distribution base vehicle 20 based on the position information of the distribution base vehicle 20. Overall loss in terms of transit time when the plural distribution vehicles 12 return to the distribution base in order to pick up distribution items is thereby reduced.

As explained above, the distribution base mobility system 10 of the present exemplary embodiment enables a reduction in overall loss when the plural distribution vehicles 12 that distribute distribution items return to the distribution base in order to pick up the distribution items. This enables the number collections and deliveries per day across the entire allocated district of the distribution base vehicle 20 to be increased.

### Modified Examples of Exemplary Embodiment

In the above exemplary embodiment, the transit plan creation section 320 illustrated in FIG. 4 creates a transit plan based on information acquired by the information acquisition section 310 such that at its shortest, the transit time of distribution items in a state carried by the distribution base vehicle 20 is as close as possible to zero. However, configuration of a transit plan creation section is not limited thereto. Namely, a transit plan creation section (320) may apply different logic when creating a transit plan based on information acquired by an information acquisition section (310), as long as the transit plan created reduces overall loss when plural distribution vehicles (12) move to an exchange location for distribution item exchange with a distribution base vehicle (20) in order to pick up distribution items. For example, as a modified example of the above exemplary embodiment, a transit plan creation section (320) may create a transit plan based on information acquired by an information acquisition section (310) so as to minimize a total transit distance of distribution vehicles (12), serving as plural moving bodies, when moving to an exchange location for distribution item exchange with a distribution base vehicle (20) in order to pick up distribution items.

As another modified example of the above exemplary embodiment, in addition to the configuration of the above exemplary embodiment, a notification section (330) may also notify distribution vehicles (12) serving as moving bodies of a transit plan created by a transit plan creation section (320). In the case of such a modified example, an additional step in which a CPU (30A) notifies the distribution vehicles (12) of the transit plan may be provided following immediately after step S103 in FIG. 5.

In the above exemplary embodiment, the CPU 30A creates the transit plan at step S101 of the flowchart illustrated in FIG. 5, after which the CPU 30A does not create an updated version of the transit plan during the subsequent processing in FIG. 5. However, a processing flow may be configured such that an updated version of the transit plan is created at a predetermined timing. Namely, a modified example of the above exemplary embodiment may adopt a processing flow in which a CPU (30A) creates an updated version of the transit plan in cases in which negative determination is made at step S107 in FIG. 5 and a predetermined condition is satisfied. After a distribution base vehicle (20) has been notified of this updated version of the transit plan, processing returns to step S104. In cases in which negative determination is made at step S107 and the predetermined condition is not satisfied, processing returns to step S104 without updating the transit plan. Note that “cases in which the predetermined condition is satisfied” may for example refer to cases in which a predetermined duration has elapsed since the transit plan (or the most recent transit plan in cases in which an updated version of the transit plan has been created) was created.

Although the distribution management device 30 creates distribution plans for the distribution vehicles 12 in the above exemplary embodiment, in a modified example of the above exemplary embodiment, an information processing device other than a distribution management device (30) may create distribution plans for distribution vehicles (12), and the distribution management device (30) may then acquire these distribution plans.

Although the plural moving bodies that distribute distribution items are configured by the distribution vehicles 12 illustrated in FIG. 1 in the above exemplary embodiment, the plural moving bodies that distribute distribution items may be configured by moving bodies other than these distribution vehicles, for example by drones or robots.

Although autonomously driven vehicles are applied as the distribution vehicles 12 and the distribution base vehicle 20 in the above exemplary embodiment, as a modified example of the above exemplary embodiment, vehicles that are not autonomously driven vehicles may be applied as distribution vehicles (12) serving as moving bodies, and a vehicle that is not an autonomously driven vehicle may be applied as a distribution base vehicle (20).

Note that the respective processing executed by the CPUs 14A, 22A, 30A illustrated in FIG. 2A, FIG. 2B, and FIG. 3 reading and executing software (a program) in the above exemplary embodiment may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The various processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

The program described in the above exemplary embodiment may be provided in a format recorded on a non-transitory computer-readable recording medium such as compact disc read only memory (CD-ROM), digital versatile disc read only memory (DVD-ROM), or universal serial bus (USB) memory. Alternatively, the program may be provided in a format downloadable from an external device through a network.

Note that the exemplary embodiment and modified examples described above may be combined as appropriate.

Although an example of the present disclosure has been described above, the present disclosure is not limited to the above description, and various other modifications may be implemented within a range not departing from the spirit of the present disclosure.

An object of the present disclosure is to provide a distribution base mobility system capable of reducing overall loss when plural moving bodies that distribute distribution items return to a distribution base in order to pick up distribution items.

A first aspect is a distribution base mobility system that includes: a distribution base vehicle that is mobile and configures a distribution base for exchanging distribution items with a plurality of moving bodies that distribute distribution items in respective designated areas; and a processor that is configured to: acquire position information of the distribution base vehicle, position information for a location where the distribution base vehicle is able to park to exchange distribution items between the distribution base vehicle and the moving bodies, and information relating to a distribution request from a user; create a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and notify the distribution base vehicle of the created transit plan, and notify the moving bodies of position information of the distribution base vehicle based on the acquired information.

According to the first aspect, the distribution base vehicle is mobile and configures a distribution base for exchanging distribution items with plural moving bodies configured to distribute distribution items in respective designated areas. The processor acquires position information of the distribution base vehicle, position information for a location where the distribution base vehicle is able to park to exchange distribution items between the distribution base vehicle and the moving bodies, and information relating to a distribution request from a user. The processor then creates a transit plan including a transit destination and a transit timing of the distribution base vehicle based on the acquired information so as to reduce overall loss when the plural moving bodies move to an exchange location for distribution item exchange with the distribution base vehicle in order to pick up distribution items.

The processor also notifies the distribution base vehicle of the created transit plan, and notifies the moving bodies of position information of the distribution base vehicle based on the acquired information. The distribution base vehicle accordingly moves according to the transit plan, and the moving bodies that need to pick up distribution items move to an appropriate exchange location for distribution item exchange with the distribution base vehicle based on the position information of the distribution base vehicle. This enables overall loss when the plural moving bodies return to the distribution base in order to pick up distribution items to be reduced.

A second aspect is the distribution base mobility system of the first aspect, wherein the processor is configured to: acquire information relating to a factor having a possibility to affect a transit time of at least one of the distribution base vehicle or the moving bodies; and create the transit plan based on the acquired information, such that a number of distribution items in a state carried by the distribution base vehicle becomes zero in a shortest time.

According to the second aspect, the processor further acquires information relating to a factor that might affect a transit time of at least one out of the distribution base vehicle or the moving bodies. The processor then creates the transit plan based on the acquired information such that the number of the distribution items in a state carried by the distribution base vehicle becomes zero in the shortest time. This enables overall loss in terms of transit time when the plural moving bodies return to the distribution base in order to pick up distribution items to be efficiently reduced.

A third aspect is the distribution base mobility system of the first aspect, wherein the processor is configured to create the transit plan based on the acquired information so as to minimize a total transit distance of the plurality of moving bodies moving to the exchange location for distribution item exchange with the distribution base vehicle in order to pick up distribution items.

According to the third aspect, the processor further creates the transit plan so as to minimize the total transit distance of the plural moving bodies moving to an exchange location for distribution item exchange with the distribution base vehicle in order to pick up distribution items. This enables overall loss in terms of transit distance when the plural moving bodies return to the distribution base in order to pick up distribution items to be efficiently reduced.

A fourth aspect is the distribution base mobility system of any of the first to the third aspect, wherein the processor is configured to notify the moving bodies of the transit plan.

According to the fourth aspect, the processor further notifies the moving bodies of the transit plan, thereby enabling the moving bodies to move in consideration of the transit plan.

The distribution base mobility system according to the present disclosure is capable of reducing overall loss when plural moving bodies that distribute distribution items return to a distribution base in order to pick up distribution items.

What is claimed is:

1. A distribution base mobility system comprising:
a distribution base vehicle that is mobile and configures a distribution base for exchanging distribution items with a plurality of moving bodies that distribute distribution items in respective designated areas; and
a processor that is configured to:
acquire position information of the distribution base vehicle, position information for a location where the distribution base vehicle is able to park to exchange distribution items between the distribution base vehicle and the moving bodies, and information relating to a distribution request from a user;
create a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and
notify the distribution base vehicle of the created transit plan, and notify the moving bodies of position information of the distribution base vehicle based on the acquired information.

2. The distribution base mobility system of claim 1, wherein the processor is configured to:
acquire information relating to a factor having a possibility to affect a transit time of at least one of the distribution base vehicle or the moving bodies; and
create the transit plan based on the acquired information, such that a number of distribution items in a state carried by the distribution base vehicle becomes zero in a shortest time.

3. The distribution base mobility system of claim 1, wherein the processor is configured to create the transit plan based on the acquired information so as to minimize a total transit distance of the plurality of moving bodies moving to the exchange location for distribution item exchange with the distribution base vehicle in order to pick up distribution items.

4. The distribution base mobility system of claim 1, wherein the processor is configured to notify the moving bodies of the transit plan.

5. A distribution management device comprising:
a memory; and
a processor coupled to the memory, the processor being configured to:
acquire position information of a distribution base vehicle that is mobile and configures a distribution base for exchanging distribution items with a plurality of moving bodies that distribute distribution items in respective designated areas, position information for a location where the distribution base vehicle is able to park to exchange distribution items between the distribution base vehicle and the moving bodies, and information relating to a distribution request from a user;
create a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and
notify the distribution base vehicle of the created transit plan, and notify the moving bodies of position information of the distribution base vehicle based on the acquired information.

6. The distribution management device of claim 5, wherein the processor is configured to:
acquire information relating to a factor having a possibility to affect a transit time of at least one of the distribution base vehicle or the moving bodies; and
create the transit plan based on the acquired information, such that a number of distribution items in a state carried by the distribution base vehicle becomes zero in a shortest time.

7. The distribution management device of claim 5, wherein the processor is configured to create the transit plan based on the acquired information so as to minimize a total transit distance of the plurality of moving bodies moving to the exchange location for distribution item exchange with the distribution base vehicle in order to pick up distribution items.

8. The distribution management device of claim 5, wherein the processor is configured to notify the moving bodies of the transit plan.

9. A distribution management method comprising:
by a processor,
acquiring position information of a distribution base vehicle that is mobile and configures a distribution base for exchanging distribution items with a plurality of moving bodies that distribute distribution items in respective designated areas, position information for a location where the distribution base vehicle is able to park to exchange distribution items between the distribution base vehicle and the moving bodies, and information relating to a distribution request from a user;
creating a transit plan including a transit destination and a transit timing of the distribution base vehicle, based on the acquired information, so as to reduce overall loss in a case in which the plurality of moving bodies move to an exchange location for distribution item exchange with the distribution base vehicle in order to pick up distribution items; and
notifying the distribution base vehicle of the created transit plan, and notifying the moving bodies of position information of the distribution base vehicle based on the acquired information.

10. The distribution management method of claim 9, further comprising:
acquiring information relating to a factor having a possibility to affect a transit time of at least one of the distribution base vehicle or the moving bodies; and
creating the transit plan based on the acquired information, such that a number of distribution items in a state carried by the distribution base vehicle becomes zero in a shortest time.

11. The distribution management method of claim 9, further comprising creating the transit plan based on the acquired information so as to minimize a total transit distance of the plurality of moving bodies moving to the exchange location for distribution item exchange with the distribution base vehicle in order to pick up distribution items.

12. The distribution management method of claim 9, wherein the transit plan is notified to the moving bodies.
